(19) United States
(12) Patent Application Publication
(10) Pub. No.: US 2025/0253070 A1
(43) Pub. Date: Aug. 7, 2025

(54) CABLE WITH VARIABLE PITCH

(71) Applicant: Amphenol Corporation, Wallingford, CT (US)

(72) Inventor: Matthew S. Wright, Madison, CT (US)

(73) Assignee: Amphenol Corporation, Wallingford, CT (US)

(21) Appl. No.: 19/039,547

(22) Filed: Jan. 28, 2025

Related U.S. Application Data
(60) Provisional application No. 63/626,525, filed on Jan. 29, 2024.

(51) Int. Cl. H01B 11/10; H01B 11/20; H01B 13/016

(52) U.S. Cl. CPC H01B 11/1025; H01B 11/1091; H01B 11/20; H01B 13/016

(57) ABSTRACT

A high frequency cable may include at least one insulative strip wrapped around its cable shield with a non-uniform pitch. Cables may include at least one signal conductor, an insulator around the at least one signal conductor, and a cable shield that surrounds the at least one signal conductor. Pitch of an insulative strip may indicate a distance between edges of successive wrappings about the cable. Cables described herein may be manufactured with a non-uniform pitch, and the non-uniform pitch reduces signal attenuation at certain high frequencies. Because the cables described herein have lower attenuation at those high frequencies, the cables may transmit higher bit rate signals, allowing the cable to transfer more data between high performance electronic components.

### RELATED APPLICATIONS

This application claims priority under 35 U.S.C. § 119(e) to U.S. Provisional Application Ser. No. 63/626,525, titled “CABLE WITH VARIABLE PITCH,” filed on Jan. 29, 2024, which is hereby incorporated herein by reference in its entirety.

### TECHNICAL FIELD

Disclosed embodiments relate to cables with high frequency performance, including twinax cables operable at data rates above 212 Gbps, including operable at 224 Gbps.

### BACKGROUND

Cables provide signal paths with high signal integrity, particularly for high frequency signals, such as those above 40 Gbps using a non-return-to-zero (NRZ) protocol or above 50 Gbps using a pulse amplitude modulation protocol such as PAM4. Each cable has one or more signal conductors, which is surrounded by at least one dielectric material. The at least one dielectric material, in turn, is surrounded by a conductive layer, which serves as a ground conductor. A protective jacket, often made of plastic, may surround these components. Additionally, the jacket or other portions of the cable may include fibers or other structures for mechanical support.

The components of the cable that predominately impact signal propagation, i.e., the signal conductor, the at least one dielectric layer and conductive layer, are conventionally generally uniform over the length of the cable. Non-uniformities on a signal path, such as might be created by changes in shape or material of the components, give rise to changes in impedance or promote mode conversion, which reduce signal integrity. Loss of signal integrity may be manifested as insertion loss, return loss, crosstalk or other undesirable effects.

One type of cable, referred to as a “twinax cable,” supports transmission of a differential signal. Twinax has a balanced pair of signal wires embedded in dielectric and encircled by a conductive layer serving as a ground conductor. That conductive layer is sometimes referred to as the cable shield. One or more insulative layers may surround the cable shield. This layers may be formed by wrapping insulative tape around the shield signal wires or may be extruded, for example.

The cable shield may be formed using foil, such as aluminized Mylar wrapped around the dielectric. The conductive layer influences the characteristic impedance in the cable and provides shielding that reduces crosstalk between signal conductors in twinax cables that may be routed together as a cable bundle.

A twinax cable can optionally have a drain wire. Unlike a signal wire, which is generally coated with a dielectric to prevent electrical contact with other conductors in the cable, the drain wire may be uncoated so that it contacts the conductive layer at multiple points over the length of the cable. At an end of the cable where the cable is to be terminated to a connector or other terminating structure, the protective jacket, dielectric and the foil may be removed, leaving portions of the signal wires and the drain wire exposed at the end of the cable. These wires may be attached to a connector. The signal wires may be attached to conductive elements serving as signal contacts in the connector. The drain wire may be attached to ground conductors in the connector, which may serve as ground contacts of the connector. In this way, a ground return path may be continued from the cable through the connector to a component mated to the connector. In drainless cables, the conductive layer may be attached directly to ground conductors in the connector.

The cable shield may be formed by wrapping strips of conductive foil, with or without a backing such as Mylar, around the insulated wire. A common arrangement is to spirally wrap the conductive foil. FIG. 1 illustrates a segment of a cable 1000 with a spirally wrapped shield 1002. FIG. 1 shows that the uniform width n conductive strips are wrapped with a uniform spacing between the edge of the conductive strip on one turn around the cable and the edge on the next turn. This separation, as well as the number of turns per unit length can be a measure of the pitch P of the wrapping. Though not shown in FIG. 1, one or more insulative layers may be applied over the cable shield.

In other instances, the shield may be wrapped longitudinally. FIG. 2 shows a segment of a twinax cable, which in this case has a drain wire 122 in addition to two signal wires 110 cach surrounded by insulator 112. In this example, the cable shield 114 is formed by wrapping conductive foil around the conductors such that the two edges of the foil come together at a scam that extends along the length of the cable. The shield is wrapped with one or more strips of tape. Two such tapes 116 and 118 are shown in FIG. 2. Those two tapes are wound spirally in opposite directions. An additional layer, here shown as jacket 120 may be applied for mechanical and environmental protection. In the example of FIG. 2, different length segments of each of each of the cable layers is removed to expose at least a portion of each layer. Further detail of the construction and performance of such a cable is shown in U.S. Pat. No. 7,790,981.

### SUMMARY

According to aspects of the disclosure, there is provided a high frequency cable, comprising: at least one signal conductor; a cable shield surrounding the at least one signal conductor; and at least one insulative strip wrapped around the cable shield with a non-uniform pitch.

Optionally, the at least one insulative strip is spirally wrapped.

Optionally, the cable shield is spirally wrapped; and the spirally wrapped cable shield and the at least one insulative strip have different pitches.

Optionally, the cable shield is longitudinally wrapped.

Optionally, each signal conductor of the at least one signal conductor is surrounded by an insulator and the cable shield is outside the insulator; and each signal conductor of the at least one signal conductor has a diameter of 26 AWG or smaller.

Optionally, each insulative strip of the at least one insulative strip has a uniform width; and each insulative strip of the at least one insulative strip has a width between 2 mm and 10 mm.

Optionally, each insulative strip of the at least one insulative strip comprises a polymer tape.

Optionally, the high frequency cable further comprises a conductive layer affixed to each insulative strip of the at least one insulative strip, and each insulative strip of the at least one insulative strip is Mylar and the conductive layer is metal foil.

Optionally, the at least one insulative strip comprises two, counter-wound insulative strips. Optionally, the high frequency cable comprises a drainless twinax cable.

Optionally, the high frequency cable comprises a twinax cable comprising a drain wire.

Optionally, a width of the at least one insulative strip varies along a length of the high frequency cable; and each insulative strip of the at least one insulative strip has a width between 2 mm and 10 mm.

Optionally, the high frequency cable supports a data rate of 224 Gbps.

Optionally, an average pitch of the at least one insulative strip is in a range between 1 mm and 7 mm.

Optionally, the pitch of the at least one insulative strip varies by at least +/−5% over a 1 m length of the high frequency cable.

Optionally, the pitch of the at least one insulative strip varies periodically along a length of the high frequency cable; and the pitch of the at least one insulative strip varies with a period in a range of 0.5 to 2 meters.

Optionally, the pitch of the at least one insulative strip varies periodically along a length of the high frequency cable; and the pitch of the at least one insulative strip varies sinusoidally.

According to aspects of the disclosure, there is provided a method of manufacturing a high frequency cable, the method comprising: surrounding at least one signal conductor with a cable shield; and pulling the surrounded at least one signal conductor past at least one wrapping head while each of the at least one wrapping heads rotating about the surrounded at least one signal conductor and dispensing an insulative strip, wherein a linear velocity at which the surrounded at least one signal conductor is pulled past the at least one wrapping head and/or a rotational velocity of the at least one wrapping head varies while the high frequency cable is manufactured. Optionally, the rotational velocity varies periodically.

Optionally, the linear velocity varies periodically.

### BRIEF DESCRIPTION OF DRAWINGS

FIG. 1 is a sketch of a cable segment with a known spirally wrapped shield.

FIG. 2 is a sketch of cable segment with a longitudinally wrapped shield and two polymer tapes.

FIG. 3 is a schematic illustration of a cable manufacturing process for manufacturing a cable with a variable pitch insulative wrapping layer.

FIGS. 4A and 4B show a comparison of signal strength as a function of frequency passing through a cable with the structure of FIG. 2 with uniform pitch of the insulative tape and with a non-uniform pitch.

FIGS. 5A and 5B are images showing an arrangement of wrapping layers of an exemplary cable.

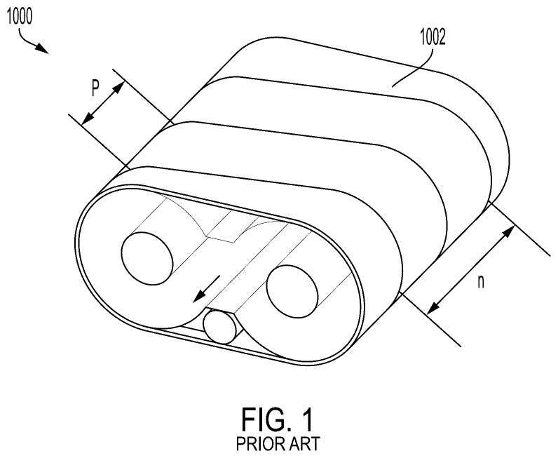

### DETAILED DESCRIPTION

The inventors have recognized and appreciated that a cable with tape surrounding a cable shield with non-uniform pitch increases the frequency range over which the cable can operate in comparison to a cable with tape wrapped with uniform pitch. The tape may be insulative. An insulative tape may be an elongated strip of a material that would generally be regarded as an insulator, such as MYLAR, PTFE or other polymer. An insulative material, for example, may have a bulk conductivity of less than half the bulk conductivity of the cable shield, and, in some examples, more than an order of magnitude or more than 4 or more orders of magnitude less. The conductivity, for example, may be less than 10⁻¹⁰/ohm-m.

An insulative tape optionally may, but need not, include an adhesive layer. An insulative layer may, for example, adhere the insulative tape to the cable shield when the insulative tape is wrapped directly onto the cable shield. Alternatively or additionally, the tape may be mechanically integrated into the cable in other ways, such as by an adhesive applied on the shield, surface adhesion of overlapping regions of the insulative tape in successive windings, or heating the insulative layer to fuse the overlapping regions of the insulative tape in successive windings.

Optionally, conductive material may be attached to the insulative tape. The insulative tape, for example, may be Mylar with a metal, such as aluminum, deposited or adhered to a surface of the tape.

Accordingly, a high frequency cable may include at least one insulative strip wrapped around its cable shield with a non-uniform pitch. Cables may include at least one signal conductor, an insulator around the at least one signal conductor, and a cable shield that surrounds the at least one signal conductor. Pitch of an insulative strip may indicate a distance between edges of successive wrappings about the cable. Cables described herein may be manufactured with a non-uniform pitch, and the non-uniform pitch reduces signal attenuation at certain high frequencies. Because the cables described herein have lower attenuation at those high frequencies, the cables may transmit higher bit rate signals, allowing the cable to transfer more data between high performance electronic components.

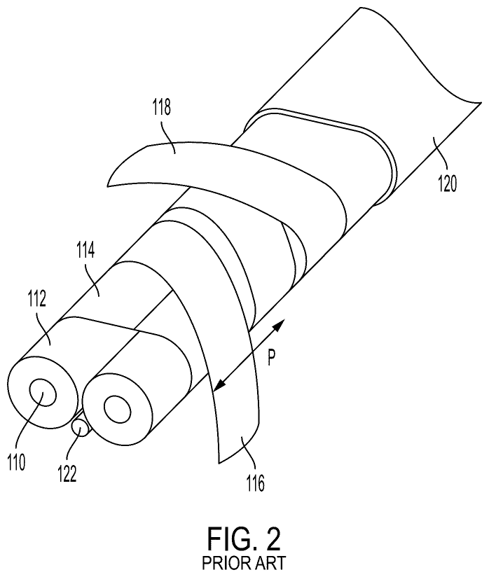

In the example of FIG. 2, tapes 116 and 118 are wound in opposite directions around cable shield 114. As illustrated the cable has a longitudinally wrapped cable shield 114 and spirally wrapped insulative tape 116 and 118 over the cable shield. In this example, the tapes are wrapped with a substantially uniform pitch P. As shown in FIG. 2, a cable 100 may comprise a differential data transmission cable having at least a pair of conductors 110. Here, FIG. 2 is a plan view showing the overall configuration of a first embodiment of the data transmission.

In FIG. 2 each of the conductors 110 is coated with an insulation 112, such as a plastic material. The outer periphery of the insulation 112 is successively covered with a shielding tape 114, two layers of polymeric tapes 116 and 118, and a jacket 120 as an optional component.

In some embodiments, a grounding drain wire 122 is also provided along the insulated conductors 110, so as to be contained inside the shielding tape 114 together with the conductors 110, thought the cable may also be drainless. The conductors 110 (coated with the insulation 112) and the drain wire 122 constitute the core of the cable. The position of the drain wire 122 is not confined as shown in FIG. 2. The drain wire 122 may be located in a horizontal position so as to be adjacent to or in between the conductors 110 like a flat ribbon tape structure. Various drain wire positions are known in the art and could be used.

Various methods can be considered for covering the conductors 110 (coated with the insulation 112) with the shielding tape 114. For example, the conductors 110 may be longitudinally wrapped with the shielding tape 114 such that both ends of the shield tape 114 overlap each other along the longitudinal direction of the conductors 110, as shown in FIG. 2, which may be referred to as a “longitudinal wrap.”

When a cable is a differential data transmission cables, at least a pair of conductors contained inside the cable 100 are located in a state parallel to each other.

The conductors 110 are composed of a single wire conductor formed of, for example, a soft copper wire, a tin-plated soft copper wire, a silver-plated copper alloy wire, and the like or of a stranded wire conductor made by stranding the single wires. Other metal materials, such as aluminum, steel, and the like that are commonly used in making conductors for cables, may be used.

The insulation 112 may be composed of a polymeric material which can be, but is not limited to, polyethylene, polypropylene, copolymer of ethylene and tetrafluoroethylene (ETFE), copolymer of tetrafluoroethylene and hexafluiropropylene (FEP), polytetrafluoroethylene (PTFE) resin, copolymer of tetrafluoroethylene and perfluoroalkoxy (PFA), fluorine-containing rubber, or mixtures thereof.

In some embodiments, the shielding tape 114 includes a metallic sheet coated with an adhesive on the surface of the metallic sheet that faces the insulated conductors 110. The adhesive may secure the shielding tapes to the core, thus minimizing one leg of the core sliding in relation to the other when the cable is bent.

In accordance with some embodiments, surrounding the shielding tape 114, there may be two layers of polymeric tapes 116 and 118 comprised of a polymeric sheet having an adhesive on one surface thereof to form an adhesive tape. The polymeric tapes 116 and 118 are wrapped spirally around the shielding tape 114 and may be in reverse directions relative to each other. For example, if the first polymeric tape 116 is wrapped in a clockwise direction, the second polymeric tape 118 is wrapped in a counterclockwise direction; and vice versa. The polymeric tapes 116 and 118 may be constructed of a plastic, such as Mylar, a polyester. Mylar is a biaxially oriented, thermoplastic film made from ethylene glycol and dimethyl terephthalate (DMT). In some embodiments, the tapes are wrapped such that the adhesive coated surfaces face each other to bind the polymeric tapes together. In some embodiments, the interface between the first polymeric tape 116 and the shielding tape 114 contains no adhesive. Besides Mylar, other polymeric films, such as Kapton, may be used.

The jacket 120, although optional, may be a polymeric resin, which can be, but is not limited to, polyvinyl chloride (PVC), polyethylene, polypropylene, copolymer of ethylene and tetrafluoroethylene (ETFE), copolymer of tetrafluoroethylene and hexafluiropropylene (FEP), polytetrafluoroethylene (PTFE) resin, copolymer of tetrafluoroethylene and perfluoroalkoxy (PFA), fluorine-containing rubber, and combinations thereof. The jacket 120 can be extruded around the outer periphery of the polymeric tapes 116 and 118 in a uniform thickness by an extruder, or the like.

Although FIG. 2 shows an embodiment in which a core comprises of a pair of parallel wires, more or fewer than two parallel wires can be included in a core. For example, three, four, or more parallel insulated conductors 110 may be used as a core of a communication cable 100.

In another embodiment, a communication cable can include a plurality of cores. Each core may contain a pair of insulated conductors and an optional drain wire that are successively covered by a shielding tape, and two layers of polymeric tapes. The plurality of cores may then be covered with an outer jacket. In some embodiments, the plurality of cores may be wrapped with a binder tape, such as a spiral wrapped polyester tape, and/or a secondary shield prior to the jacket. In this embodiment, the secondary shield can include a shielding tape and/or a braided shield.

In some examples, the cable may be configured as in FIG. 2, except that tapes 116 and 118 may be wrapped with a non-uniform pitch. One or more tapes, such as tapes 116 and 118 may be wrapped with a pitch that changes along the length of the cable. Each of the tapes may be a polymer tape with a width in a range between about 2 mm and about 10 mm, for example. In this example, the tapes have a uniform width along the length of the cable and a variable pitch is created by varying the percentage of the width of the tape in one turn around the cable that overlaps the tape from the prior turn. In alternative implementations the width of the tape may vary along the length of the cable such that a non-uniform pitch results.

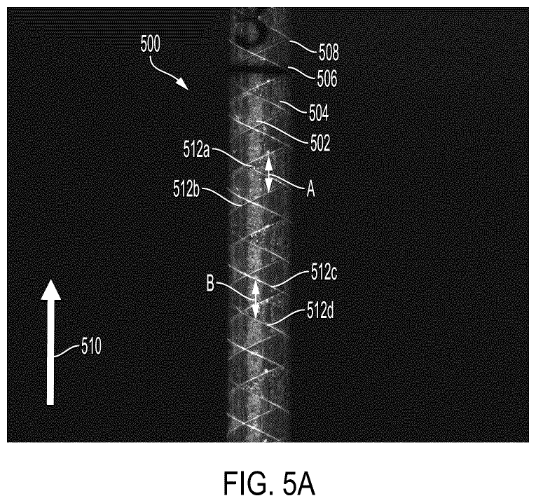

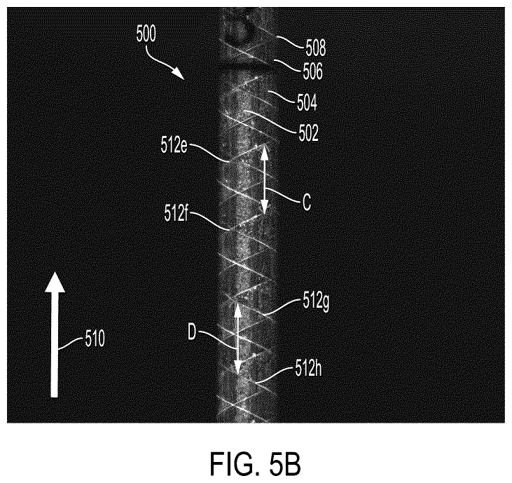

FIGS. 5A and 5B are images showing an arrangement of wrapping layers of an exemplary cable. FIG. 5A is illustrative of pitch of wrapping layers of a cable, and FIG. 5B is illustrative of width of the wrapping layers of the cable. FIGS. 5A and 5B show a cable 500, having one or more signal wires 502, each surrounded by an insulator 504, in turn surrounded by a cable shield 506, with one or more insulative tapes 508 wrapped around the cable shield. The one or more insulative tapes 508 may be constructed from similar materials and wrapped in a similar manner as other tapes described herein.

Tapes may be wrapped having a pitch. FIG. 5A illustrates pitch of the wrapped one or more insulative tapes 508. As shown in FIG. 5A, the one or more insulative tapes 508 may be wrapped in wrapping direction 510. In other words, as tape is wrapped around the cable, the wrapped tape extends further along the wrapping direction 510. In FIG. 5A, there may be a first edge 512a and a second edge 512b. The first edge 512a may correspond to a leading edge, along the wrapping direction, of a first wrap of tape less far along the wrapping direction, and the second edge 512b may correspond to a leading edge of a second wrap of tape further along the wrapping direction. In other embodiments, the first edge 512a and second edge 512b may cach correspond trailing edges. The distance A between the first edge 512a and the second edge 512b shows the pitch of the wrapping at that point along the cable. A similar pitch B may be shown between a third edge 512c and a fourth edge 514d (which may both be leading edges or may both be trailing edges). Pitch B is shown for tape wrapped in an opposite rotational direction than the tape for which pitch A is shown, though both tapes are wrapped along the wrapping direction 510.

Tapes may have a width. FIG. 5B illustrates width of the wrapped one or more insulative tapes 508. In FIG. 5B, there may be a fifth edge 512e and a sixth edge 512f. The fifth edge 512e may correspond to a leading edge of a wrap of tape and the sixth edge 512f may correspond to a trailing edge of that same wrap of tape. The distance C between the fifth edge 512e and the sixth edge 512f shows the width of the wrapping at that point along the cable. A similar width D may be shown between a seventh edge 512g (which may be a leading edge of a wrap) and an eight edge 514h (which may be a trailing edge of that wrap). Pitch D is shown for tape wrapped in an opposite rotational direction than the tape for which pitch C is shown, though both tapes are wrapped along the wrapping direction 510.

Regardless of how a non-uniform pitch is created, the pitch of one or more insulative tapes may vary along the cable such that the pitch varies up to about 5% or up to about 10% in some examples. In other examples, the pitch may vary up to about 15%. The average pitch, for example, may be in a range of 1 mm to 7 mm. Such a pitch may be achieved with a tape that is or comprises a polymer strip. The width of the tape may be, for example, between 2 mm and 10 mm.

The pitch may vary periodically along the length of the cable. In one period, the pitch may increase from a minimum value to a maximum value and then return to the minimum value. The pitch variations may be continuous over the length of one period. For example, the pitch may increase monotonically from a minimum value to a maximum value, and then return to its minimum value. In other examples, the pitch may vary continuously over multiple periods. As one example, the pitch variations may be sinusoidal.

The period of pitch variations may be between about 0.5 m and 2 m. As a specific example, the period of pitch variations may be about 1 m.

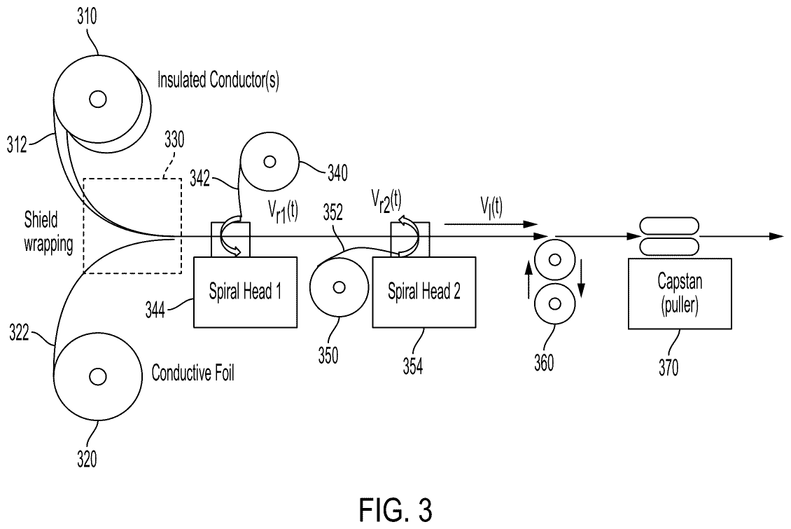

FIG. 3 illustrates a block diagram illustrative of a manufacturing process for a high speed cable. In the illustrative process, insulated conductors 312 and conductive foil 322 are inputs. In this example, two insulated conductors 312 are illustrated. Such inputs may be used, for example, to make a twinax cable. The process alternatively may be performed with a single insulated conductor or more than two insulated conductors. In the example illustrated, the signal conductors for the cable being manufactured are provided on carrier such as one or more schools 310. In this example, the signal conductors are surrounded by an insulator when supplied as an input to the manufacturing process. In other examples, the conductors may be surrounded by an insulator as part of a continuous process such that the input to the manufacturing process for a high speed cable is the bare wire.

In this example, insulated conductors 312 are input to a wrapping stage 330. Wrapping stage 330 may be performed in equipment that wraps the insulated conductors with conductive foil 322. Conductive foil, for example, may be supplied on a carrier 320. Wrapping stage 330 may position insulated conductors 312 in parallel and wrap conductive foil 322 around those insulated conductors. Conductive foil 322 may be longitudinally wrapped around the insulated conductors 312 or may be wrapped spirally around the insulated conductors.

Regardless of how the conductive foil is wrapped, those wrapped conductors may pass to stage 344. At stage 344, a spiral head rotating around the wrapped conductors may wrap an insulative tape 342 around the conductive foil 322 serving as cable shield. In the example of FIG. 3, insulative tape 342 is supplied on a carrier, such a spool 340.

Further down the manufacturing line, the insulated conductors wrapped in the conductive foil may enter stage 354. At stage 354, a second spiral head wraps a second insulative tape 352 around the shielded insulated conductors. In the example of FIG. 3, insulative tape 352 is supplied on a carrier, such a spool 350.

In the illustrated example, the spiral head at stage 344 rotates in the opposite direction of spiral head at stage 354. Such a configuration may result in a counter wrapped cable, such as is shown in FIG. 2.

The cable being manufactured in FIG. 3 may be pulled through the successive stages of the manufacturing process. In this example, the cable is pulled by capstan 370. The cable may be pulled through stages 344 and 354 at a velocity, here illustrated as linear velocity V_{L}(t). The spiral heads at stages 344 and 354 may rotate about the cable at a velocity, here illustrated as a rotational velocity Vᵣ₁(t) and Vᵣ₂(t). The rotational velocities for the spiral heads in the manufacturing process may be the same or may be different. In this example, rotational velocities Vᵣ₁(t) and Vᵣ₂(t) differ only in their direction. In other examples, the magnitude of the rotational velocity at one or more of the spiral heads may be different, which may result in different tapes wrapping the cable shield having different pitches. One or more of those pitches may vary along the length of the cable.

A cable with a variable pitch for an insulative wrap may be achieved by varying one or more of the velocities V_{L}(t), Vᵣ₁(t) and/or Vᵣ₂(t) as the insulative wrapping is applied. In the example illustrated, the linear velocity V_{L}(t) is varied. Sheaves 360 may be included to accommodate the variable speed, while enabling the capstan 370 to run at a constant speed. Alternatively or additionally, variations in linear velocity may be accommodated in subsequent stages (not pictured) such as by take-up reel that accepts cable at a variable rate.

In other examples, a cable with a variable pitch insulative wrap may be formed by varying the rotational velocities of the spiral heads, Vᵣ₁(t) and/or Vᵣ₂(t) in the example of FIG. 3. As yet another example, both linear and rotational velocities may vary.

Regardless of which one or more of the velocities which impact the pitch is varied, the velocity may be varied according to a pattern that provides one or more insulative tapes wrapped around the conductive foil 322 with a pitch that varies along the length of the cable. That pitch may vary periodically, such as by varying the velocity periodically.

Though not illustrated for simplicity, other manufacturing steps may be performed either before or after any of the illustrated stages. For example, the insulated conductors may be coated with an adhesive to ensure that they have a stable relative position before the conductive foil 322 is applied. As another example, once the insulated conductors 312 are aligned, a further insulative coating may be extruded around them to space the signal conductors from the conductive foil 322 serving as the cable shield. Accordingly, though FIG. 3 illustrates a configuration in which the insulative tapes are applied directly to a conductive foil serving as the cable shield, the insulative tapes may be indirectly applied in some embodiments. As another example, following wrapping the cable core with one or more insulative tapes, a jacket may be extruded over the insulative tape. Similarly, following the stages illustrated in FIG. 3, the cable may be wound on a spool or other carrier for shipment or movement to other manufacturing operations.

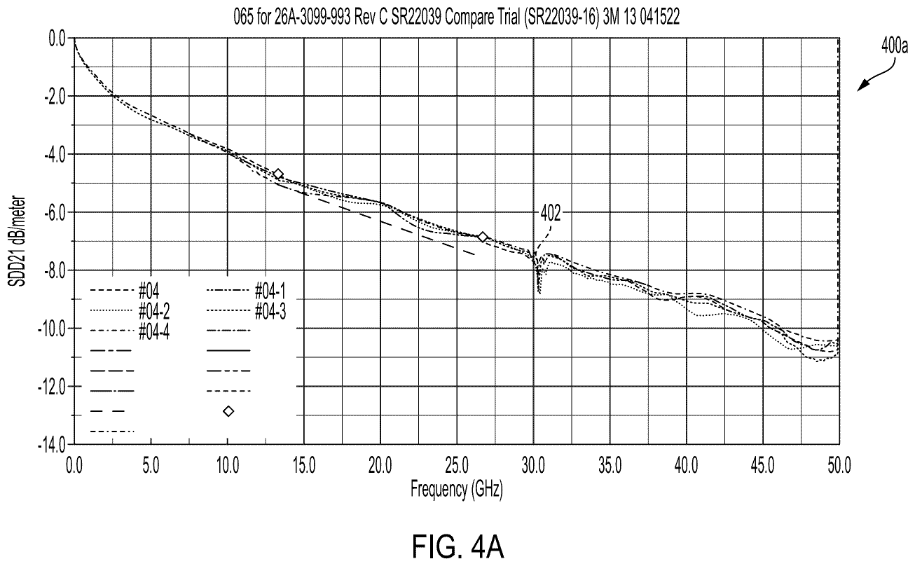

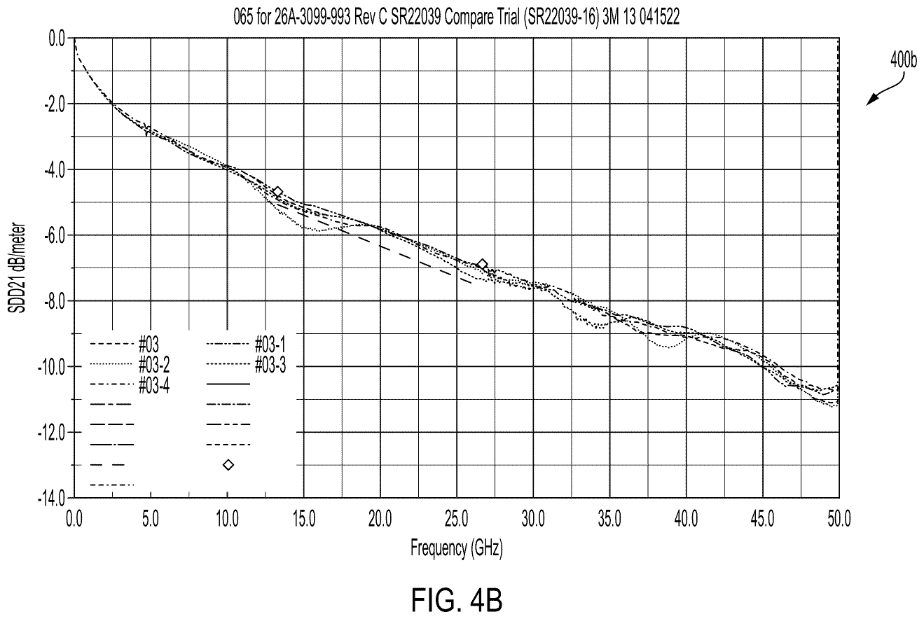

FIGS. 4A and 4B illustrate the difference in cable performance that results from a varying pitch for one or more insulative tapes. Plot 400a of FIG. 4A and plot 400b of FIG. 4B illustrate the same measure of signal integrity for signals passing through a segment of a cable. In this example, that measure of signal integrity is referred to as SDD21. Such a measure may indicate the amount of signal energy injected into one end of the cable relative to the amount of signal energy at the far end of the cable. Conversely, the plots in FIGS. 4A and 4B may illustrate the amount of signal attenuation within the cable. Here, signal attenuation is indicated in units of dB per meter of cable length.

As can be seen by a comparison of plot 400a to plot 400b, cables manufactured with and without variable pitch insulative wrapping show a signal attenuation that increases with frequency. However, plot 400a, representing cables with generally uniform wrapping pitch includes a feature 402. In this example, feature 402 indicates a signal attenuation that increases suddenly around of frequency of 30 GHz.

In this example, feature 402 impacts signals with frequency components in the range of about 30 GHz to about 31 GHz. Even though feature 402 spans a relatively narrow range of frequencies, such a precipitous change in attenuation as a function of frequency can have a significant impact on signals passing through the cable if those signals have frequency components in that relatively narrow range. That impact can result in a device receiving the signals through the cable to improperly decoding the signals or failing to detect them entirely, which disrupts communication over the cable. As a result, a cable with a feature, such as feature 402, might not be classified as usable with signals that include frequency components in the frequency range of the feature. In other words, cables as represented by plot 400a may be rated for use with signals that have a highest fundamental frequency less than 30 GHz.

In contrast, plot 400b shows similar signal integrity, but without feature 402. The cables represented by plot 400b are not limited in highest fundamental frequency by feature 402 and may operate at higher frequencies. As bit rate of a cable is related to the frequencies that the cable can support, being able to pass higher frequencies through a cable equates to a higher bit rate signals passing through the cable.

As a specific example, feature 402 might result in cables that are rated for operation at less than 212 Gbps and possibly less than 120 Gbps using PAM4 modulation. In contrast, cables with variable pitch insulative wrap may be rated for operation at greater than 120 Gbps, and possibly greater than 212 Gbps or 224 Gbps using PAM4 modulation.

In the example associated with FIGS. 4A and 4B, the cables may have shielding that is longitudinally wrapped with two counter-would insulative tapes with a sinusoidal variation in pitch with a variation of about 10% from maximum to minimum over one period, with the period of the variation being about 1 m. However, use of variable pitch insulative wrapping may improve the high frequency performance of cables with other designs.

According to some embodiments, the pitch of insulative strips may be varied in additional or alternative manners. For example, in some embodiments, a width of the strips may vary along the length of the strips. In some embodiments, an outer mechanical size and/or geometry of components of the cable (such as the insulator or shield) may be varied along the length of the cable, which effectively change the pitch of a spiral tape applied at a constant feed rate. In some embodiments, the effect of the strips (or the insulator) may be varied electrically instead of or in addition to being varied mechanically. For example, a dielectric constant of strips and/or the insulator may be varied along the length of the cable such that the electrical length of the pitch varies. In some embodiments, the dielectric constant may be varied by removing portions of the strips or insulator, such as by providing channels (e.g., via cutting) of variable width and/holes (e.g., via drilling) of variable diameter in the dielectric along the length of the cable. In other embodiments different shapes may be used to provide mechanical benefits as well as electrical benefits.

Examples of arrangements that may be implemented according to some embodiments include the following:
1. A high frequency cable, comprising:
a. At least one signal conductor;
b. A cable shield surrounding the at least one signal conductor; and
c. At least one insulative strip wrapped around the cable shield with a non-uniform pitch.
2. The high frequency cable of example 1, wherein the cable shield is spirally wrapped.
3. The high frequency cable of example 2, wherein the at least one insulative strip is spirally wrapped.
4. The high frequency cable of example 3, wherein the spirally wrapped cable shield and the at least one insulative strip have different pitches.
5. The high frequency cable of example 1, wherein the cable shield is longitudinally wrapped.
6. The high frequency cable of any preceding example wherein each signal conductor of the at least one the at least one signal conductor is surrounded by an insulator and the cable shield is outside the insulator.
7. The high frequency cable of any preceding example wherein each insulative strip of the at least one insulative strip has a uniform width.
8. The high frequency cable of any preceding example wherein each insulative strip of the at least one insulative strip is a polymer tape.
9. The high frequency cable of any preceding example further comprising a conductive layer affixed to each insulative strip of the at least one insulative strip.
10. The high frequency cable of any example 9 wherein each insulative strip of the at least one insulative strip is Mylar and the conductive layer is metal foil.
11. The high frequency cable of any preceding example further comprising a jacket surrounding the at least one insulative strip.
12. The high frequency cable of any preceding example wherein the at least one signal conductor is a pair of signal conductors.
13. The high frequency cable of any preceding example wherein the at least one insulative strip comprises two, counter-wound insulative strips.
14. The high frequency cable of any preceding example wherein the cable is a twinax cable.
15. The high frequency cable of example 14, wherein the twinax cable is drainless.
16. The high frequency cable of example 14, wherein the twinax cable comprises a drain wire.
17. The high frequency cable of any preceding example wherein the signal conductor has a diameter of 26 AWG or smaller.
18. The high frequency cable of any preceding example, wherein the at least one insulative strip has at least one dimension that varies along the length of the cable.
19. The high frequency cable of example 18, wherein a width of the at least one insulative strip varies along the length of the cable.
20. The high frequency cable of any preceding example, wherein the cable supports a data rate of 224 Gbps.
21. The high frequency cable of any preceding example, wherein the average pitch is in a range between 1 mm and 7 mm.
22. The high frequency cable of any preceding example, wherein the pitch varies by at least +/−5% over a 1 m length of the cable.
23. The high frequency cable of any preceding example, wherein the pitch varies by at least +/−9% over a 1 m length of the cable.
24. The high frequency cable of any preceding example, wherein the pitch varies periodically along the length of the cable.
25. The high frequency cable of example 24, wherein the pitch varies with a period in the range of 0.5 to 2 meters.
26. The high frequency cable of any preceding example, wherein the pitch varies sinusoidally.
27. The high frequency cable of any preceding example, wherein each insulative strip of the at least one insulative strip has a width between 2 mm and 10 mm.
28. A method of manufacturing a high frequency cable, the method comprising:
a. surrounding at least one signal conductor with a cable shield; and
b. pulling the wrapped at least one signal conductor past at least one wrapping head while each of the at least one wrapping heads rotating about the wrapped at least one signal conductor and dispensing an insulative strip,
c. wherein the linear velocity at which the wrapped at least one signal conductor is pulled past the at least one wrapping head and/or the rotational velocity of the at least one wrapping head varies while the high frequency cable is manufactured.
29. The method of example 28, wherein the rotational velocity varies periodically.
30. The method of example 28, wherein the linear velocity varies periodically.

Terms signifying direction, such as “upwards” and “downwards,” were used in connection with some embodiments. These terms were used to signify direction based on the orientation of components illustrated or connection to another component, such as a surface of a printed circuit board to which a termination assembly is mounted. It should be understood that electronic components may be used in any suitable orientation. Accordingly, terms of direction should be understood to be relative, rather than fixed to a coordinate system perceived as unchanging, such as the earth's surface.

Further, though advantages of the present invention are indicated, it should be appreciated that not every embodiment of the invention will include every described advantage. Some embodiments may not implement any features described as advantageous herein and in some instances. Further, the illustrated embodiments are exemplary rather than limiting. For example, embodiments of cable cores with parallel wires are given. Optionally, in some examples a pair of wires may be twisted. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Also, circuits and modules depicted and described may be reordered in any order, and signals may be provided to enable reordering accordingly.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A high frequency cable, comprising:
at least one signal conductor;
a cable shield surrounding the at least one signal conductor; and
at least one insulative strip wrapped around the cable shield with a non-uniform pitch.

2. The high frequency cable of claim 1, wherein the at least one insulative strip is spirally wrapped.

3. The high frequency cable of claim 2, wherein:
the cable shield is spirally wrapped; and
the spirally wrapped cable shield and the at least one insulative strip have different pitches.

4. The high frequency cable of claim 1, wherein the cable shield is longitudinally wrapped.

5. The high frequency cable of claim 1, wherein:
each signal conductor of the at least one signal conductor is surrounded by an insulator and the cable shield is outside the insulator; and
each signal conductor of the at least one signal conductor has a diameter of 26 AWG or smaller.

6. The high frequency cable of claim 1, wherein:
each insulative strip of the at least one insulative strip has a uniform width; and
each insulative strip of the at least one insulative strip has a width between 2 mm and 10 mm.

7. The high frequency cable of claim 1, wherein each insulative strip of the at least one insulative strip comprises a polymer tape.

8. The high frequency cable of claim 1, further comprising a conductive layer affixed to each insulative strip of the at least one insulative strip,
wherein each insulative strip of the at least one insulative strip is Mylar and the conductive layer is metal foil.

9. The high frequency cable of claim 1, wherein the at least one insulative strip comprises two, counter-wound insulative strips.

10. The high frequency cable of claim 1, wherein the high frequency cable comprises a drainless twinax cable.

11. The high frequency cable of claim 1, wherein the high frequency cable comprises a twinax cable comprising a drain wire.

12. The high frequency cable of claim 1, wherein:
a width of the at least one insulative strip varies along a length of the high frequency cable; and
each insulative strip of the at least one insulative strip has a width between 2 mm and 10 mm.

13. The high frequency cable of claim 1, wherein the high frequency cable supports a data rate of 224 Gbps.

14. The high frequency cable of claim 1, wherein an average pitch of the at least one insulative strip is in a range between 1 mm and 7 mm.

15. The high frequency cable of claim 1, wherein the pitch of the at least one insulative strip varies by at least +/−5% over a 1 m length of the high frequency cable.

16. The high frequency cable of claim 1, wherein:
the pitch of the at least one insulative strip varies periodically along a length of the high frequency cable; and
the pitch of the at least one insulative strip varies with a period in a range of 0.5 to 2 meters.

17. The high frequency cable of claim 1, wherein:
the pitch of the at least one insulative strip varies periodically along a length of the high frequency cable; and
the pitch of the at least one insulative strip varies sinusoidally.

18. A method of manufacturing a high frequency cable, the method comprising:
surrounding at least one signal conductor with a cable shield; and
pulling the surrounded at least one signal conductor past at least one wrapping head while each of the at least one wrapping heads rotating about the surrounded at least one signal conductor and dispensing an insulative strip,
wherein a linear velocity at which the surrounded at least one signal conductor is pulled past the at least one wrapping head and/or a rotational velocity of the at least one wrapping head varies while the high frequency cable is manufactured.

19. The method of claim 18, wherein the rotational velocity varies periodically.

20. The method of claim 18, wherein the linear velocity varies periodically.
